(19) United States
(12) Patent Application Publication
(10) Pub. No.: US 2006/0186249 A1
(43) Pub. Date: Aug. 24, 2006

(54) Holding structure and webbing winding apparatus

(75) Inventors: Yasuho Kitazawa, Aichi-ken (JP); Hitoshi Takamatsu, Aichi-ken (JP); Masaki Yasuda, Aichi-ken (JP); Kazuhiko Aihara, Aichi-ken (JP); Toshio Nakashima, Aichi-ken (JP); Tomonori Nagata, Aichi-ken (JP)

Correspondence Address: NIXON PEABODY, LLP, 401 9TH STREET, NW, SUITE 900, WASHINGTON, DC, 20004-2128, US

(73) Assignee: KABUSHIKI KAISHA TOKAI-RIKA-DENKI-SEISAKUSHO, Aichi-ken (JP)

(21) Appl. No.: 11/343,233

(22) Filed: Jan. 31, 2006

(30) Foreign Application Priority Data
Feb. 3, 2005 (JP) 2005-27243

(51) Int. Cl. B60R 22/36; B65H 75/48

(52) U.S. Cl. 242/379

(57) ABSTRACT

A holding structure for holding a member to be held that is provided in a holding element by the holding element. The holding structure comprises a holding pawl which is provided in the holding element, having a basal part positioned on the lateral side of the member to be held as well as a pawl part provided in the tip part of the basal part, and with which the pawl part engages with the member to be held, thereby holding the member to be held; and restriction means which, when the basal part is deformed in a direction in which it separates from the member to be held, engages with the holding pawl for restricting the deformation of the basal part.

### CROSS-REFERENCE TO RELATED APPLICATION

This application claims priority under 35 USC 119 from Japanese Patent Application No. 2005-027243, the disclosure of which is incorporated by reference herein.

### BACKGROUND OF THE INVENTION

1. Field of the Invention

The present invention relates to a holding structure which holds an element to be held by a pawl, and a webbing winding apparatus which winds a continuous length strap-like webbing belt for constraining the body of a rider on a vehicle for storing it.

2. Description of the Related Art

The seat belt apparatus which constrains the body of a rider who has seated on a seat of a vehicle with a continuous length strap-like webbing belt comprises a webbing winding apparatus fixed to the vehicle body on the lateral side of the seat. This type of webbing winding apparatus has a locking mechanism for reliably holding the body of a rider who has worn the webbing belt in a vehicle sudden deceleration state, and one example thereof is disclosed in Japanese Patent Laid-Open publication No. 2003-212086.

The locking mechanism comprises a locking clutch element which is coaxially, relatively rotatable with respect to the spool. In addition, the locking mechanism comprises a spring (a return spring) which is rotated together with the spool. One end of this spring is engaged with the above-mentioned locking clutch element, and when the spool is rotated, the energizing force of the spring causes the locking clutch element to rotate, following up the spool.

However, when the vehicle is brought into a sudden deceleration state, resulting in the webbing belt being abruptly pulled, and the spool trying to abruptly rotate in the pulling-out direction, the locking clutch element cannot follow up the spool, whereby a relative rotation is generated between the locking clutch element and the spool. When a relative rotation is thus generated between the locking clutch element and the spool, a pawl which is provided on the other end side of the spool in the axial direction is moved to engage with an internally toothed ratchet formed on the frame of the webbing winding apparatus.

Thereby, the spool is restricted from rotating in the pulling-out direction, which is a direction of rotation when the webbing belt is pulled out, and in its turn, the webbing belt being pulled out from the spool is prevented.

Thus the webbing belt is restricted from being pulled out from the spool, whereby, even if the body of a rider that tries to inertially move toward substantially the front side of the vehicle by a sudden deceleration of the vehicle pulls the webbing belt, the webbing belt will not be pulled out from the spool. Therefore, the webbing belt loaded on the body of the rider will reliably hold the body of the rider, which restricts the inertial movement of the body of the rider toward substantially the front side of the vehicle.

With the locking mechanism as mentioned above, when the spool is restricted from being rotated, or when some other mechanism is operated, for example, a certain great external force is applied to a rotating element, such as the locking clutch element, or the like, which is relatively rotatable with respect to the spool.

Therefore, in order to restrict the displacement in the axial direction of the rotating element, it can be considered that, for example, a holding pawl is provided on the lateral side of the rotating element in the casing which accommodates the respective members of the locking mechanism, and further, the pawl part at the tip thereof is rendered to face the rotating element on the lateral side in the axial direction for engaging with the rotating element, whereby the displacement of the rotating element in the axial direction is restricted.

However, even if such a holding pawl is formed, the excessive pressing force applied to the pawl part of the holding pawl by the rotating element which tries to displace in the axial direction will deform the holding pawl, resulting in the displacement of the rotating element in the axial direction being unable to be sufficiently restricted.

### SUMMARY OF THE INVENTION

The present invention has been made in view of the above circumstances, and provides a holding structure and a webbing winding apparatus which restricts the deformation of the holding pawl due to a pressing force applied by the member to be held, such as a rotating element, or the like, and reliably restricts the displacement of the member to be held, such as a rotating element, or the like.

A first aspect of the present invention provides a holding structure for holding a member to be held that is provided in a holding element by the holding element, comprising a holding pawl which is provided in the holding element, having a basal part positioned on the lateral side of the member to be held as well as a pawl part provided in the tip part of the basal part, and with which the pawl part engages with the member to be held, thereby holding the member to be held; and a restriction member which, when the basal part is deformed in a direction in which it separates from the member to be held, engages with the holding pawl for restricting the deformation of the basal part.

According to the holding structure of the aspect as described above, the basal part of the holding pawl provided on the holding element is positioned on the lateral side of the member to be held, and when the member to be held tries to move in a direction in which it separates from the holding element, the pawl part engages with the member to be held, thereby restricting the movement of the member to be held in a direction in which it separates from the holding element, which results in the holding of the member to be held in the holding element being maintained.

In addition, if, when the member to be held is engaged by the pawl part, the pressing force applied to the pawl part by the member to be held is excessive, and by this pressing force, the basal part of the holding pawl tries to deform, the restriction member engages with the holding pawl, and this engagement by the restriction member restricts the deformation of the basal part.

Thus, by the deformation of the basal part being restricted, the engagement of the pawl part with the member to be held is maintained, whereby, if an excessive pressing force as mentioned above is applied to the pawl part, the holding of the member to be held in the holding element is maintained.

A second aspect of the present invention provides a holding structure for holding a member to be held that is provided in a holding element by the holding element, comprising a holding pawl which is provided in the holding element, having a basal part positioned on the lateral side of the member to be held as well as a pawl part provided in the tip part of the basal part, and with which the pawl part engages with the member to be held, thereby holding the member to be held; an accommodation member which accommodates at least the member to be held and the holding pawl from the side facing the holding member, sandwiching the member to be held and the holding pawl; and a restriction member which is provided on the inner peripheral surface of the accommodation member, and which, when the basal part is deformed in a direction in which it separates from the member to be held, engages with the holding pawl for restricting the deformation of the basal part.

A third aspect of the present invention provides a webbing winding apparatus, comprising a frame which directly or indirectly supports a spool to which the base end side of a continuous length strap-like webbing belt is latched; a rotating element which is coaxially rotatable with respect to the spool on the lateral side of the frame; a holding element which is mounted to the frame for supporting the rotating element rotatably; a holding pawl which has a basal part provided on the holding element on the lateral side of the rotating element, and with which a pawl part provided in the tip part of the basal part faces the rotating element on the side opposite to the holding element through the rotating element, engaging with the rotating element, thereby restricting the displacement of the rotating element along the axial direction of the rotating element; and a restriction member which, when the basal part is deformed in a direction in which it separates from the rotating element, engages with the holding pawl, restricting the deformation of the basal part.

With the webbing winding apparatus of the aspect as described above, the basal part of the holding pawl provided on the holding element is positioned on the lateral side of the rotating element, and when the rotating element tries to move in a direction in which it separates from the holding element along the axial direction of the rotating element, the pawl part engages with the rotating element, thereby restricting the movement of the rotating element in a direction in which it separates from the holding element, which results in the holding of the rotating element in the holding element being maintained.

In addition, if, when the rotating element is engaged by the pawl part, the pressing force applied to the pawl part by the rotating element is excessive, and by this pressing force, the basal part of the holding pawl tries to deform, the restriction member engages with the holding pawl, and this engagement by the restriction member restricts the deformation of the basal part.

Thus, by the deformation of the basal part being restricted, the engagement of the pawl part with the rotating member is maintained, whereby, if an excessive pressing force as mentioned above is applied to the pawl part, the holding of the rotating element in the holding element is maintained.

A fourth aspect of the present invention provides a webbing winding apparatus, comprising a frame which directly or indirectly supports a spool to which the base end side of a continuous length strap-like webbing belt is latched; a rotating element which is coaxially rotatable with respect to the spool on the lateral side of the frame; a holding element which is mounted to the frame for supporting the rotating element rotatably; a holding pawl which has a basal part provided on the holding element on the lateral side of the rotating element, and with which a pawl part provided in the tip part of the basal part faces the rotating element on the side opposite to the holding element through the rotating element, engaging with the rotating element, thereby restricting the displacement of the rotating element along the axial direction of the rotating element; a covering member which accommodates at least the rotating element and the holding pawl from the side facing the holding member, sandwiching the rotating element and the holding pawl; and a restriction member which is provided on the inner peripheral surface of the covering member, and which, when the basal part is deformed in a direction in which it separates from the rotating element, engages with the holding pawl, restricting the deformation of the basal part.

As described above, according to the present invention, the deformation of the holding pawl by a pressing force applied by the rotating element or the member to be held can be effectively suppressed, which reliably restricts the displacement of the rotating element or the member to be held.

### BRIEF DESCRIPTION OF THE DRAWINGS

Preferred embodiments of the present invention will be described in detail based on the following figures, wherein:

FIG. 1 is an exploded perspective side view illustrating the configuration of the critical part of a webbing winding apparatus 10 pertaining to a first embodiment of the present invention (a webbing winding apparatus 10 to which a holding structure pertaining to a first embodiment of the present invention is applied);

FIG. 2 is a fragmentary cross-sectional view illustrating the configuration of the critical part of the present webbing winding apparatus 10 pertaining to the first embodiment of the present invention (a webbing winding apparatus 10 to which a holding structure pertaining to the first embodiment of the present invention is applied);

FIG. 3 is a schematic sectional view illustrating the state in which an restriction rib suppresses the deflection; and

FIG. 4 is a fragmentary cross-sectional view illustrating the configuration of the critical part of the present webbing winding apparatus 10 pertaining to the first embodiment of the present invention (a webbing winding apparatus 10 to which a holding structure pertaining to the second embodiment of the present invention is applied).

### DETAILED DESCRIPTION OF THE INVENTION

### Configuration of First Embodiment

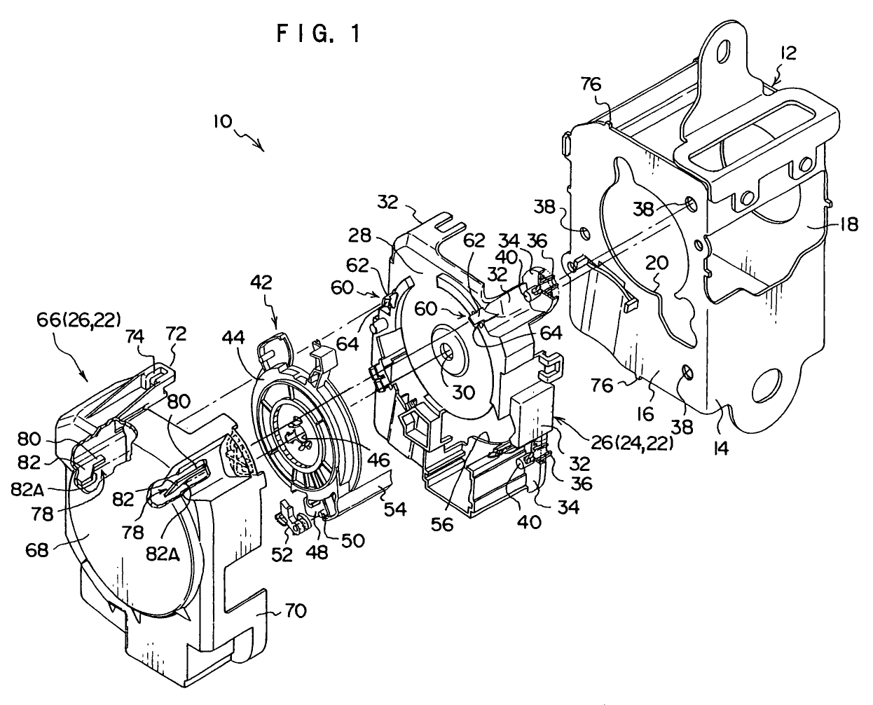

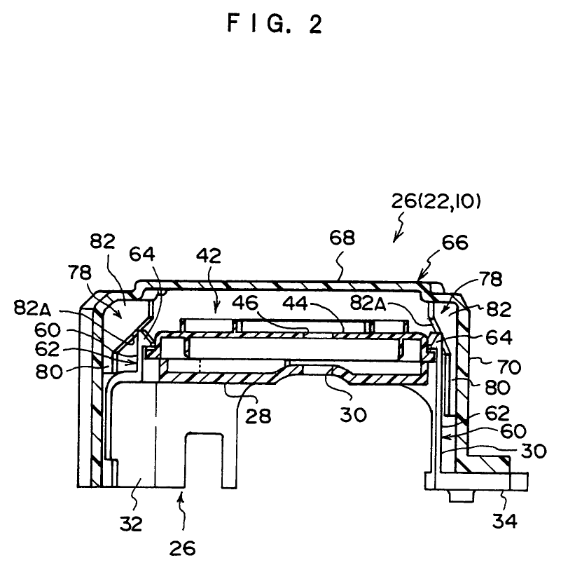

FIG. 1 is an exploded perspective side view illustrating the configuration of the critical part of a webbing winding apparatus 10 pertaining to a first embodiment of the present invention (a webbing winding apparatus 10 to which a holding structure pertaining to a first embodiment of the present invention is applied). In addition, FIG. 2 is a sectional view illustrating the configuration of the critical part of the present webbing winding apparatus 10 pertaining to the first embodiment of the present invention (the webbing winding apparatus 10 to which the present holding structure is applied).

As shown in FIG. 1, the present webbing winding apparatus 10 comprises a frame 12. The frame 12 comprises a plate-like back plate 14 which thickness direction is to be substantially along the vehicle crosswise direction, for example, and the back plate 14 is fixed to the vehicle body in the vicinity of the lower end part of the center pillar, for example, by means of a bolt, or the like, whereby the webbing winding apparatus 10 of the present is mounted to the vehicle body.

From both ends of the back plate 14 in the width direction thereof that is substantially along the vehicle longitudinal direction in the state in which it is mounted to the vehicle, a pair of leg plates 16, 18 are formed, being bent, toward the inner side in the vehicle lateral direction (the compartment side in a substantially crosswise direction of the vehicle). Between these leg plate 16 and leg plate 18, a spool (not shown) which axial direction is aligned to the facing direction of the leg plate 16 and the leg plate 18 is disposed. To this spool, the base end part of a continuous length strap-like webbing belt (not shown) is latched, and the spool is rotated in the winding direction, i.e., one of the circumferential directions thereof, by the energizing force of an energizing member, such as a spiral spring, or the like, whereby the webbing belt is wound up from the base end side and stored.

In the leg plate 16, a hole part 20 which penetrates the leg plate 16 in the thickness direction thereof is formed, and one end of the spool in the axial direction thereof, or one end of a torsion shaft which is coaxially and integrally provided with respect to the spool penetrates through the hole part 20 to be protruded to the outside of the frame 12.

In addition, on the side of the leg plate 16 that faces away from the leg plate 18 (in other words, the outer side of the leg plate 16 along the facing direction of the leg plates 16, 18), a sensor holder 26 as a holding element constituting a casing 24 for a locking mechanism 22 as a locking member is provided. The sensor holder 26 comprises a bottom wall 28.

The bottom wall 28 is formed in the shape of a plate which is substantially parallel with respect to the leg plate 16. In the bottom wall 28, a through-hole 30 is formed, and therethrough, one end of the spool, or one end of the torsion shaft which is coaxially and integrally provided with respect to the spool penetrates. In the outer peripheral part of the bottom wall 28, a vertical wall 32 is formed. A prescribed portion of the vertical wall 32 is cut out, and one part of a pretensioner (not shown) disposed between the bottom wall 28 and the leg plate 16 is passed through the cutout portion.

In addition, at the end of the vertical wall 32 on the side facing away from the bottom wall 28, a plurality of facing walls 34 are formed, and in these facing walls 34, a cylindrical part 36 which is split at the tip is formed, being protruded, toward the leg plate 16 side. Corresponding to these cylindrical parts 36, through-holes 38 are formed in the leg plate 16, and when the sensor holder 26 is loaded on the frame 12, the cylindrical parts 36 penetrate the through-holes 38.

In addition, on the above-mentioned facing wall 34, a pin 40 is formed. The pin 40 is formed, being protruded, coaxially with respect to the cylindrical part 36 toward the side facing away from the cylindrical part 36, and when the connection portion between the pin 40 and the facing wall 34 is broken to force the pin 40 into the cylindrical part 36 in the state in which the cylindrical part 36 penetrates the through-hole 38, the pin 40 will spread out the cylindrical part 36. Thereby, the cylindrical part 36 is prevented from being dropping off from the through-hole 38, and the sensor holder 26 is loaded on the frame 12.

On the other hand, on the side of the bottom wall 28 that faces away from the leg plate 16, a sensor gear 42 as a member to be held or a rotating element is provided. The sensor gear 42 comprises a plate-like main body 44. At substantially the center of the main body 44, a through-hole 46 is formed, and therethrough, one end of the spool, or one end of the torsion shaft which is coaxially and integrally provided with respect to the spool penetrates. Thereby, the main body 44 (i.e., the sensor gear 42) is pivotally supported by the one end of the spool or the one end of the torsion shaft coaxially and relatively rotatably with respect to the spool.

In addition, in a part of the outer periphery of the main body 44, a holding part 48 is provided. The holding part 48 comprises a shaft 50 which is parallel with respect to the axial direction of the main body 44. The shaft 50 is formed, being protruded, from the holding part 48 toward the side facing away from the sensor holder 26. On the shaft 50, a connection pawl 52 is pivotally supported to be rockable around the shaft 50.

Under this connection pawl 52, an acceleration sensor (not shown) is provided, and when the acceleration sensor detects a vehicle sudden deceleration state, a pressing protrusion constituting the acceleration sensor pushes up the connection pawl 52, thereby rocking the connection pawl 52 around the shaft 50.

Further, corresponding to the connection pawl 52, the locking mechanism 22 comprises a V-shaped gear (not shown). The V-shaped gear is a ratchet wheel in the outer peripheral part of which ratchet teeth are formed, being rotatably provided coaxially and integrally with respect to the spool on the lateral side of the sensor gear 42.

The connection pawl 52 is rocked to be contacted with or separated from the ratchet teeth of the V-shaped gear, and when the connection pawl 52 is pushed up by the pressing protrusion of the acceleration sensor to be rocked, it approaches the ratchet teeth of the V-shaped gear to be engaged with the ratchet teeth of the V-shaped gear. In this engaged state, when the V-shaped gear is rotated in the direction of rotation of the spool when the webbing belt which is wound up on the spool is pulled out (hereafter this direction of rotation is called “pulling-out direction” for convenience), the sensor gear 42 is rotated together with the V-shaped gear.

In addition, the holding part 48 is provided with a square bar-like pressing piece 54. The pressing piece 54 is formed so as to extend from the holding part 48 to the sensor holder 26 side, the tip side penetrating through a hole part 56 formed in the bottom wall 28 of the sensor holder 26 to extend to the outside of the sensor holder 26, and entering the hole part 20 of the leg plate 16.

Corresponding to the tip side of the pressing piece 54 entering the hole part 20, a locking pawl (not shown) is provided in the hole part 20. The locking pawl is pivotally supported by the frame 12 or another member mechanically connected to the frame 12 so as to be rockable around the shaft which is parallel with respect to the spool, and when the sensor gear 42 is rotated in the pulling-out direction together with the V-shaped gear, the pressing piece 54 presses the pawl to rock it for the pawl to approach a locking base (not shown) provided inside the hole part 20 coaxially and integrally with the spool or one end of the torsion shaft.

In the outer peripheral part of the locking base, ratchet teeth are formed, and when the pawl approaches the locking base, the pawl is engaged with the ratchet teeth of the locking base, restricting the rotation of the locking base in the pulling-out direction, and in its turn, the rotation of the spool in the pulling-out direction.

On the other hand, on the bottom wall 28, a plurality of holding pawls 60 are formed. The holding pawl 60 comprises a bar-like basal part 62. The basal part 62 is formed, being protruded, from the bottom wall 28 toward the side facing away from the leg plate 16 on the lateral side outside the rotation radius of the main body 44 (sensor gear 42).

Further, at the tip of the basal part 62, a pawl part 64 is formed. The pawl part 64 is formed so as to protrude from the tip of the basal part 62 toward the inner side along the radial direction of the main body 44 (the sensor gear 42), and faces the main body 44 on the side of the main body 44 that faces away from the bottom wall 28 along the axial direction of the main body 44.

In addition, on the side of the sensor holder 26 that faces away from the leg plate 16, a sensor cover 66 is provided, and in the space surrounded by the bottom wall 28 of the sensor holder 26 and the sensor cover 66, the respective members constituting the locking mechanism 22 including the above-mentioned sensor gear 42 are accommodated and disposed.

As shown in FIG. 1 and FIG. 2, the sensor cover 66 comprises a bottom wall 68 which is substantially parallel with respect to the bottom wall 28. In the outer peripheral part of the bottom wall 68, a peripheral wall 70 is extended toward the sensor holder 26 side. The peripheral wall 70 is formed to such a size that, inside thereof, the bottom wall 28 of the sensor holder 26 can be accommodated.

In addition, in a prescribed portion of the tip of the peripheral wall 70 (that is on the side opposite to the end facing away from the bottom wall 28), a fitting piece 72 is formed. In the fitting piece 72, a through-hole 74 penetrating it in a direction along the thickness thereof is formed.

Corresponding to the fitting piece 72, a fitting protrusion 76 is formed, being protruded, in the outer peripheral part of the leg plate 16, and with the fitting protrusion 76 entering the through-hole 74 in the fitting piece 72, the sensor cover 66 is fixed, being fitted, to the leg plate 16.

In addition, inside of the sensor cover 66, restriction ribs 78 constituting a restriction member as engagement parts are formed. The restriction ribs 78 are formed in the inner peripheral part of the peripheral wall 70, for example, and in the state in which the sensor cover 66 is loaded on the leg plate 16 (the frame 12), are positioned on the side opposite to the main body 44 of the sensor gear 42 through the basal part 62 of the holding pawl 60.

The restriction rib 78 comprises a straight line part 80. The straight line part 80 is formed substantially in parallel with respect to the basal part 62 of the holding pawl 60. The end of the straight line part 80 on the side facing away from the peripheral wall 70 is butted against the basal part 62, or a previously set clearance is formed between the end of the straight line part 80 on the side facing away from the peripheral wall 70 and the basal part 62.

When such a clearance is provided between the straight line part 80 and the basal part 62, the size of this clearance is not particularly limited, but in an example of the size of the clearance that can be mentioned, the clearance between the straight line part 80 and the basal part 62 is smaller than the distance from the outer peripheral part of the main body 44 to the tip of the pawl part 64 along the radial direction of the sensor gear 42.

From the end of the straight line part 80 on the bottom wall 68 side, a broader part 82 is continuously formed. The broader part 82 is formed in the shape of a hypotenuse or trapezoid which is gradually broadened from the portion connected to the straight line part 80 toward the bottom wall 68 side, and the hypotenuse part 82A thereof faces the pawl part 64 of the holding pawl 60.

### Function and Effects of First Embodiment

Next, the function of the present webbing winding apparatus 10 as well as the effects will be described.

With the present webbing winding apparatus 10, when a vehicle sudden deceleration state is detected by the acceleration sensor under the connection pawl 52, the pressing protrusion of the acceleration sensor presses the connection pawl 52 to rock the connection pawl 52 around the shaft 50. Thereby, the connection pawl 52 is engaged with the V-shaped gear which is rotated integrally with the shaft.

In the state in which the connection pawl 52 is thus engaged with the V-shaped gear, when the inertia at the time of the vehicle sudden deceleration causes the rider on the vehicle to pull the webbing belt, resulting in the spool being rotated in the pulling-out direction, the sensor gear 42 is rotated in the pulling-out direction together with the V-shaped gear.

When the sensor gear 42 is rotated in the pulling-out direction, the pressing piece 54 of the sensor gear 42 presses the pawl to cause it to move to approach the locking base. Thereby, the pawl is engaged with the locking base, resulting in the rotation of the locking base in the pulling-out direction, and in its turn, the rotation of the spool in the pulling-out direction being restricted, and the pulling-out of the webbing belt from the spool is restricted.

Herein, as described above, when the sensor gear 42 is abruptly rotated in the pulling-out direction together with the V-shaped gear, or when an excessive rotating force of the locking base which tries to rotate in the pulling-out direction is transmitted to the main body 44 of the sensor gear 42 through the pawl and the pressing piece 54, further, when the pretensioner mechanism disposed in the vicinity of the locking mechanism 22 is operated, or the like, the sensor gear 42 trying to displace not only in the circumferential direction, but also in a direction in which it separates from the sensor holder 26 along the axial direction will cause the pawl part 64 of the holding pawl 60 to engage with the main body 44, whereby, the displacement of the main body 44, in other words, the sensor gear 42 in the axial direction is restricted.

Thus, the displacement of the sensor gear 42 along the axial direction is restricted by the holding pawl 60, whereby the sensor gear 42 will not inadvertently separate from the sensor holder 26, the sensor gear 42 being rotatably held in a prescribed position.

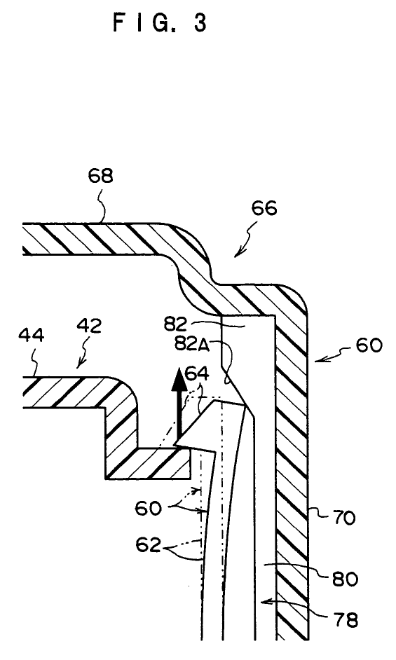

By the way, if, when the sensor gear 42 tries to separate from the sensor holder 26 along the axial direction thereof, the force of the main body 44 pressing the pawl part 64 of the holding pawl 60 is too high, the tip side of the holding pawl 60, including the pawl part 64, tries to deflect, under the force applied thereto by the main body 44, from the state as shown with an imaginary line (two-dotted line) in FIG. 3 to the state as shown with a solid line toward the outer side of the sensor gear 42 along the radial direction thereof in the state as shown with an imaginary line (two-dotted line) in FIG. 3.

Herein, with the present webbing winding apparatus 10, as described above, restriction ribs 78 are provided on the side opposite to the main body 44 of the sensor gear 42 through the holding pawl 60, and when the tip side of the holding pawl 60 tries to deflect toward the outer side of the sensor gear 42 along the radial direction thereof, the broader part 82 of the restriction rib 78 engages with the pawl part 64 of the holding pawl 60, or, although not shown in FIG. 3, the straight line part 80 of the restriction rib 78 engages with the basal part 62 of the holding pawl 60.

Thus, the restriction rib 78 engages with the holding pawl 60, thereby restricting the deflection of the holding pawl 60 toward the outer side of the sensor gear 42 along the radial direction thereof. By the deflection of the holding pawl 60 being restricted, the facing state between the pawl part 64 and the main body 44 along the axial direction of the sensor gear 42 will not be canceled, and the displacement in the axial direction of the sensor gear 42 can be reliably restricted by the pawl part 64.

### Second Embodiment

Next, a second embodiment of the present invention will be described. In describing the present embodiment, basically the same portions as those in the first embodiment will be provided with the same signs, and detailed description thereof will be omitted.

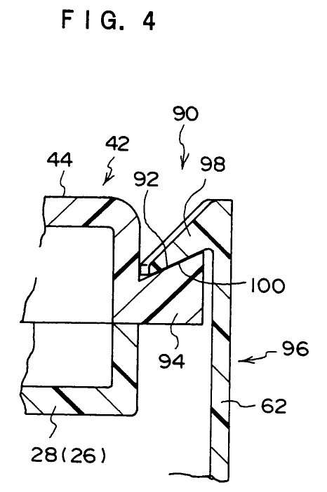

FIG. 4 is a sectional view schematically illustrating the configuration of the critical part of a webbing winding apparatus 90 pertaining to the present embodiment (a webbing winding apparatus 90 to which a holding structure pertaining to the present embodiment is applied).

As shown in this figure, in the main body 44 of a sensor gear 42 constituting the present webbing winding apparatus 90, an engagement surface 92 as a restriction member is formed. The engagement surface 92 is formed in a flange part 94 in the outer peripheral part of the main body 44, being inclined toward the inner side of the radial direction of the main body 44 with respect to the direction toward the side facing away from the leg plate 16 (not shown in FIG. 4) (the upper side in FIG. 4).

On the other hand, in the sensor holder 26 of the present webbing winding apparatus 90, a holding pawl 96 is formed in place of the holding pawl 60. In the holding pawl 96, no pawl part 64 is formed, but instead, a pawl part 98 is formed. In the pawl part 98, a facing surface 100 is formed.

The facing surface 100 is inclined toward the outer side of the radial direction of the sensor gear 42 with respect to the leg plate 16 side (the lower side in FIG. 4), and in the state in which the sensor holder 26 is loaded on the frame 12 with the sensor gear 42 being pivotally supported by the spool or one end of the torsion shaft, the facing surface 100 faces the engagement surface 92 along a direction inclined toward the radial direction of the sensor gear 42 with respect to the axial direction of the sensor gear 42.

With the present webbing winding apparatus 90 featuring the configuration as described above, when the sensor gear 42 tries to separate from the sensor holder 26 along the axial direction thereof, the engagement surface 92 will press the facing surface 100. Herein, the engagement surface 92 is inclined toward the inner side of the radial direction of the sensor gear 42 with respect to the side facing away from the leg plate 16, i.e., a direction in which it separates from the bottom wall 28 of the sensor holder 26.

Therefore, the direction of the pressing force applied to the facing surface 100 by the engagement surface 92 is a direction inclined toward the inner side of the radial direction of the sensor gear 42 with respect to the direction in which the sensor gear 42 separates from the bottom wall 28 of the sensor holder 26. Therefore, the facing surface 100 is subjected to such a pressing force the direction of which is inclined toward the inner side of the radial direction of the sensor gear 42, whereby the holding pawl 96 is suppressed from deflecting toward the outer side along the radial direction of the sensor gear 42.

Yet, in this state, if the holding pawl 96 tries to incline toward the outer side along the radial direction of the sensor gear 42, the engagement surface 92 butting against the facing surface 100 will restrict the displacement of the facing surface 100 toward the outer side along the radial direction of the sensor gear 42. Also thereby, the holding pawl 96 is suppressed from deflecting toward the outer side along the radial direction of the sensor gear 42, the facing state between the engagement surface 92 and the facing surface 100 being maintained, thus the displacement in the axial direction of the sensor gear 42 can be reliably restricted by the pawl part 98.

The respective embodiments as described above provide a configuration in which the holding structure of the present invention has been applied to the structure of the sensor gear 42 in the sensor holder 26 of the webbing winding apparatus 10, 90.

However, the holding structure of the present invention is not limited to such a structure of the sensor gear 42 in the sensor holder 26, but may be applied to the holding structure of another member in the webbing winding apparatus 10, or a member to be held in various apparatuses other than the webbing winding apparatus 10.

Hereinabove, the present invention has been described about specific embodiments, however, the present invention should not be construed, being limited to these embodiments.

In other words, a first aspect of the present invention provides a holding structure for holding a member to be held that is provided in a holding element by the holding element, comprising a holding pawl which is provided in the holding element, having a basal part positioned on the lateral side of the member to be held as well as a pawl part provided in the tip part of the basal part, and with which the pawl part engages with the member to be held, thereby holding the member to be held; and a restriction member which, when the basal part is deformed in a direction in which it separates from the member to be held, engages with the holding pawl for restricting the deformation of the basal part.

In the aspect as described above, the restriction member may be provided on the side opposite to the member to be held through the basal part, and when the basal part is deformed in a direction in which it separates from the member to be held, may engage with the holding pawl.

The aspect as described above may further comprise an accommodation member which accommodates at least the member to be held and the holding pawl, wherein the restriction member may include a rib formed on the inner peripheral surface of the accommodation member.

In the aspect as described above, the rib may include a straight line part formed in parallel with respect to the basal part of the holding pawl, and a broader part formed continuously from the straight line part to the pawl part side of the holding pawl, the broader part engaging with the pawl part of the holding pawl.

In the aspect as described above, the restriction member may include a surface formed in the member to be held that engages with the pawl part, the pawl part having a surface which engages with the member to be held; and the surface formed in the member to be held and the surface of the pawl part that engages with the member to be held may be inclined, respectively, such that they face each other, matching with each other.

In the aspect as described above, the surface of the pawl part that engages with the member to be held may be inclined toward the outer side of the member to be held, the surface formed in the member to be held being inclined toward the inner side of the member to be held.

A second aspect of the present invention provides a holding structure for holding a member to be held that is provided in a holding element by the holding element, comprising a holding pawl which is provided in the holding element, having a basal part positioned on the lateral side of the member to be held as well as a pawl part provided in the tip part of the basal part, and with which the pawl part engages with the member to be held, thereby holding the member to be held; an accommodation member which accommodates at least the member to be held and the holding pawl from the side facing the holding member, sandwiching the member to be held and the holding pawl; and a restriction member which is provided on the inner peripheral surface of the accommodation member, and which, when the basal part is deformed in a direction in which it separates from the member to be held, engages with the holding pawl for restricting the deformation of the basal part.

In the aspect as described above, the restriction member may include a rib formed on the inner peripheral surface of the accommodation member that includes a straight line part formed in parallel with respect to the basal part of the holding pawl, the straight line part engaging with the basal part of the holding pawl.

In the aspect as described above, the clearance between the rib and the basal part of the holding pawl may be shorter than the length of the engaging portion between the pawl part and the member to be held.

In the aspect as described above, the restriction member may include a rib formed on the inner peripheral surface of the accommodation member that includes a straight line part formed in parallel with respect to the basal part of the holding pawl, and a broader part formed continuously from the straight line part to the pawl part side of the holding pawl, the broader part engaging with the pawl part of the holding pawl.

A third aspect of the present invention provides a webbing winding apparatus, comprising a frame which directly or indirectly supports a spool to which the base end side of a continuous length strap-like webbing belt is latched; a rotating element which is coaxially rotatable with respect to the spool on the lateral side of the frame; a holding element which is mounted to the frame for supporting the rotating element rotatably; a holding pawl which has a basal part provided on the holding element on the lateral side of the rotating element, and with which a pawl part provided in the tip part of the basal part faces the rotating element on the side opposite to the holding element through the rotating element, engaging with the rotating element, thereby restricting the displacement of the rotating element along the axial direction of the rotating element; and a restriction member which, when the basal part is deformed in a direction in which it separates from the rotating element, engages with the holding pawl, restricting the deformation of the basal part.

In the aspect as described above, the restriction member may be provided on the side opposite to the rotating element through the basal part, and when the basal part is deformed in a direction in which it separates from the rotating element, engage with the holding pawl.

The aspect as described above may further comprise an accommodation member which accommodates at least the rotating element and the holding pawl, wherein the restriction member may include a rib formed on the inner peripheral surface of the accommodation member.

In the aspect as described above, the rib may include a straight line part formed in parallel with respect to the basal part of the holding pawl, and a broader part formed continuously from the straight line part to the pawl part side of the holding pawl, the broader part engaging with the pawl part of the holding pawl.

In the aspect as described above, the restriction member may include a surface formed in the rotating element that engages with the pawl part, the pawl part having a surface which engages with the rotating element; and the surface formed in the rotating element and the surface of the pawl part that engages with the rotating element may be inclined to be brought into surface contact with each other.

In the aspect as described above, the surface of the pawl part that engages with the rotating element may be inclined toward the outer side of the rotating element, the surface formed in the rotating element being inclined toward the inner side of the rotating element.

A fourth aspect of the present invention provides a webbing winding apparatus, comprising a frame which directly or indirectly supports a spool to which the base end side of a continuous length strap-like webbing belt is latched; a rotating element which is coaxially rotatable with respect to the spool on the lateral side of the frame; a holding element which is mounted to the frame for supporting the rotating element rotatably; a holding pawl which has a basal part provided on the holding element on the lateral side of the rotating element, and with which a pawl part provided in the tip part of the basal part faces the rotating element on the side opposite to the holding element through the rotating element, engaging with the rotating element, thereby restricting the displacement of the rotating element along the axial direction of the rotating element; a covering member which accommodates at least the rotating element and the holding pawl from the side facing the holding member, sandwiching the rotating element and the holding pawl; and a restriction member which is provided on the inner peripheral surface of the covering member, and which, when the basal part is deformed in a direction in which it separates from the rotating element, engages with the holding pawl, restricting the deformation of the basal part.

In the aspect as described above, the restriction member may include a rib formed on the inner peripheral surface of the covering member that includes a straight line part formed in parallel with respect to the basal part of the holding pawl, the straight line part engaging with the basal part of the holding pawl.

In the aspect as described above, the clearance between the rib and the basal part of the holding pawl may be shorter than the length of the engaging portion between the pawl part and the rotating element.

In the aspect as described above, the restriction member may include a rib formed on the inner peripheral surface of the covering member that includes a straight line part formed in parallel with respect to the basal part of the holding pawl, and a broader part formed continuously from the straight line part to the pawl part side of the holding pawl, the broader part engaging with the pawl part of the holding pawl.

What is claimed is:

1. A holding structure for holding a member to be held that is provided in a holding element by said holding element, comprising:
a holding pawl which is provided in said holding element, having a basal part positioned on the lateral side of said member to be held as well as a pawl part provided in the tip part of said basal part, said holding pawl holding said member to be held by said pawl part engaging with said member to be held; and
a restriction member which, when said basal part is deformed in a direction in which it separates from said member to be held, engages with said holding pawl for restricting the deformation of said basal part.

2. The holding structure of claim 1, wherein said restriction member is provided on the side opposite to said member to be held through said basal part, and when said basal part is deformed in a direction in which it separates from said member to be held, engages with said holding pawl.

3. The holding structure of claim 1, further comprising an accommodation member which accommodates at least said member to be held and said holding pawl, wherein said restriction member includes a rib formed on the inner peripheral surface of said accommodation member.

4. The holding structure of claim 3, wherein said rib includes a straight line part formed in parallel with respect to the basal part of said holding pawl, and a broader part formed continuously from said straight line part to the pawl part side of said holding pawl, said broader part engaging with said pawl part of said holding pawl.

5. The holding structure of claim 1, wherein said restriction member includes a surface formed in said member to be held that engages with said pawl part, said pawl part having a surface which engages with said member to be held, and
the surface formed in said member to be held is inclined, the surface of said pawl part that engages with said member to be held matching the inclination of the surface formed in said member to be held for one surface facing the other.

6. The holding structure of claim 5, wherein the surface of said pawl part that engages with said member to be held is inclined toward the outer side of said member to be held, the surface formed in said member to be held being inclined toward the inner side of said member to be held.

7. A holding structure for holding a member to be held that is provided in a holding element by said holding element, comprising:
a holding pawl which is provided in said holding element, having a basal part positioned on the lateral side of said member to be held as well as a pawl part provided in the tip part of said basal part, and with which said pawl part engages with said member to be held, thereby holding said member to be held;
an accommodation member which accommodates at least said member to be held and said holding pawl from the side facing said holding member, sandwiching said member to be held and said holding pawl; and
a restriction member which is provided on the inner peripheral surface of said accommodation member, and which, when said basal part is deformed in a direction in which it separates from said member to be held, engages with said holding pawl for restricting the deformation of said basal part.

8. The holding structure of claim 7, wherein said restriction member includes a rib formed on the inner peripheral surface of said accommodation member that includes a straight line part formed in parallel with respect to said basal part of said holding pawl, the straight line part engaging with said basal part of said holding pawl.

9. The holding structure of claim 8, wherein the clearance between said rib and said basal part of said holding pawl is shorter than the length of the engaging portion between said pawl part and said member to be held.

10. The holding structure of claim 7, wherein said restriction member includes a rib formed on the inner peripheral surface of said accommodation member that includes a straight line part formed in parallel with respect to the basal part of said holding pawl, and a broader part formed continuously from said straight line part to the pawl part side of said holding pawl, said broader part engaging with said pawl part of said holding pawl.

11. A webbing winding apparatus, comprising:
a frame which directly or indirectly supports a spool to which the base end side of a continuous length strap-like webbing belt is latched;
a rotating element which is coaxially rotatable with respect to said spool on the lateral side of said frame;
a holding element which is mounted to said frame for supporting said rotating element rotatably;
a holding pawl which has a basal part provided on said holding element on the lateral side of said rotating element, and with which a pawl part provided in the tip part of said basal part faces said rotating element on the side opposite to said holding element through said rotating element, engaging with said rotating element, thereby restricting the displacement of said rotating element along the axial direction of said rotating element; and
a restriction member which, when said basal part is deformed in a direction in which it separates from said rotating element, engages with said holding pawl, restricting the deformation of said basal part.

12. The webbing winding apparatus of claim 11, wherein said restriction member is provided on the side opposite to said rotating element through said basal part, and when said basal part is deformed in a direction in which it separates from said rotating element, engages with said holding pawl.

13. The webbing winding apparatus of claim 11, further comprising an accommodation member which accommodates at least said rotating element and said holding pawl, wherein said restriction member includes a rib formed on the inner peripheral surface of said accommodation member.

14. The webbing winding apparatus of claim 13, wherein said rib includes a straight line part formed in parallel with respect to the basal part of said holding pawl, and a broader part formed continuously from said straight line part to the pawl part side of said holding pawl, said broader part engaging with said pawl part of said holding pawl.

15. The webbing winding apparatus of claim 11, wherein said restriction member includes a surface formed in said rotating element that engages with said pawl part, said pawl part having a surface which engages with said rotating element, and
wherein the surface formed in said rotating element and the surface of said pawl part that engages with said rotating element are inclined to be brought into surface contact with each other.

16. The webbing winding apparatus of claim 15, wherein the surface of said pawl part that engages with said rotating element is inclined toward the outer side of said rotating element, the surface formed in said rotating element being inclined toward the inner side of said rotating element.

17. A webbing winding apparatus, comprising:
a frame which directly or indirectly supports a spool to which the base end side of a continuous length strap-like webbing belt is latched;
a rotating element which is coaxially rotatable with respect to said spool on the lateral side of said frame;
a holding element which is mounted to said frame for supporting said rotating element rotatably;
a holding pawl which has a basal part provided on said holding element on the lateral side of said rotating element, and with which a pawl part provided in the tip part of said basal part faces said rotating element on the side opposite to said holding element through said rotating element, engaging with said rotating element, thereby restricting the displacement of said rotating element along the axial direction of said rotating element;
a covering member which accommodates at least said rotating element and said holding pawl from the side facing said holding member, sandwiching said rotating element and said holding pawl; and
a restriction member which is provided on the inner peripheral surface of said covering member, and which, when said basal part is deformed in a direction in which it separates from said rotating element, engages with said holding pawl, restricting the deformation of said basal part.

18. The webbing winding apparatus of claim 17, wherein said restriction member includes a rib formed on the inner peripheral surface of said covering member that includes a straight line part formed in parallel with respect to said basal part of said holding pawl, said straight line part engaging with said basal part of said holding pawl.

19. The webbing winding apparatus of claim 18, wherein the clearance between said rib and the basal part of said holding pawl is shorter than the length of the engaging portion between said pawl part and said rotating element.

20. The webbing winding apparatus of claim 17, wherein said restriction member includes a rib formed on the inner peripheral surface of said covering member that includes a straight line part formed in parallel with respect to the basal part of said holding pawl, and a broader part formed continuously from said straight line part to the pawl part side of said holding pawl, said broader part engaging with said pawl part of said holding pawl.
